(19) United States
(12) Patent Application Publication
(10) Pub. No.: US 2017/0062078 A1
(43) Pub. Date: Mar. 2, 2017

(54) Linear converging/diverging fusion reactor and operating method for achieving clean fusion reactions

(71) Applicant: Michael Minovitch, (US)

(72) Inventor: Michael Minovitch, (US)

(21) Appl. No.: 14/756,291

(22) Filed: Aug. 24, 2015

(51) Int. Cl. G21B 1/05

(52) U.S. Cl. CPC G21B 1/05; G21Y 2004/30

(57) ABSTRACT

A fusion reactor is provided for achieving ultra-high plasma densities required for achieving clean, neutron-free, fusion reactions. This is achieved by designating the reactor with a linear geometry containing an internal plasma flow duct that converges to a point along its central longitudinal axis surrounded by a diverging containment solenoid with increasing wall thickness that generates an increasing axial magnetic field. This field compresses the plasma to ultra high densities as it is magnetically pulled toward the fusion ignition point by the solenoid's magnetic field gradient. Ignition is achieved by a plurality of high power phased-coherent laser beams converging to the ignition point. A secondary solenoid is mounted around the ignition point that magnetically deflects and focuses the ionized reaction products into a directed beam of high energy charged particles which is fed into an MHD generator thereby converting the fusion power of the reactor directly into electric power.

### BACKGROUND

During the early 1930s, theoretical physicists, in trying to explain the Sun's energy source, concluded that enormous amounts of unlimited free energy can be generated by the nuclear fusion of ionized hydrogen gas (free protons), or some other ionized substance. (See pages 31-44 in A Piece Of The Sun, Overlook Duckworth, Peter Mayer Publishers, Inc., New York, 2013 by Daniel Clery.) One of the most promising prior art fusion reactor designs was invented in the USSR during the early 1950s. The reactor design has a toroidal shape that is enclosed by a plurality of superconducting coils that magnetically compresses the plasma along its major axis. (See pages 104-107 in the Clery book.) Unfortunately, this proposed fusion reactor design, and all other fusion reactor designs in the prior art, have failed to achieve any self-sustaining fusion reaction. The main problem is that all prior art fusion reactor designs are unable to achieve the very high plasma densities required to achieve a self-sustaining fusion reaction. The fusion reaction requiring the lowest plasma density (and hence the easiest to achieve) are the Proton+Deuterium, the Proton+Tritium, and the Deuterium+Tritium reactions. Unfortunately, they all generate enormous amounts of spurious neutrons. When a high energy neutron collides with atoms, it usually renders them unstable. This is what causes the surrounding structure of all prior art fusion reactor designs to become highly radioactive because they are all based on the much easier to achieve fusion reactions which, because of the required high plasma densities, appear to be unavoidable. Since all of the fusion reactions that generate no neutrons and therefore no radioactive byproducts require much higher plasma densities, any reactor design in the prior art that finally achieves a self-sustaining fusion reaction will generate so much radiation the entire reactor structure and the surrounding area will be rendered unusable. Thus, it appears that if a self-sustaining fusion reaction is ever achieved, it will be a completely impractical way of generating useful energy for industry and commerce because of the resulting radiation damage to the structure. This was described in an article published in the Washington Post by one of the leading experts in the field of fusion reactor design—Professor Lawrence Lidsky, a professor of nuclear engineering at MIT. The article was entitled, “Our Energy Ace in the Hole Is a Joker: Fusion Won't Fly.” (See page 304 in the Clery book.) However, Clery points out that Lidsky's article was not entirely negative. Quoting from page 304, Clery stated: “But Lidsky's message was not entirely negative. He acknowledged the attractions of limitless fuel and minimal radioactive waste from fusion, but in essence he thought that fusion had taken a wrong turn and needed to start again by focusing on a different reaction that produces no neutrons: the fusion of hydrogen and boron-11. This seems ideal, but boron has five times the positive charge of hydrogen, making fusion much harder to achieve. Although some schemes for fusing hydrogen and boron have been proposed including using Sandia's Z Machine none have yet been tested.”

Another prior art fusion reactor designed to achieve a clean fusion reaction is called the Quiet-Electric-Discharge (QED) Inertial Electrostatic Confinement Fusion (IEC or IEF) Reactor pioneered by Bussard, and later by Miley. This fusion reactor design comprises a spherical vacuum chamber maintained at ultra-low pressure less than 10⁻⁶ Torr. Theoretically, the fusion process is generated by injecting electrons followed by a electrostatic discharge Unfortunately, this fusion reactor design has also failed to achieve any self-sustaining fusion reaction.

The aim of the present invention is to provide a completely new fusion reactor design that is capable, in principle, of achieving unlimited plasma densities required for achieving essentially any clean fusion reaction desired at very high power levels, limited only by the field and structural limitations of the fusion reactor's magnetic containment and compression solenoid.

### BRIEF DESCRIPTION OF THE INVENTION

A fusion reactor design and operating method is provided for achieving ultra-high plasma densities required for achieving very difficult clean self-sustaining fusion reactions that generate no neutrons. This is achieved by designing the reactor as a linear cylindrical converging/diverging magnetic solenoid with an internal conical plasma flow duct that converges to a point along its longitudinal central axis surrounded by a thick-walled, diverging magnetic confinement and compressing solenoid with increasing wall thickness that generates an increasing axial magnetic field inside the duct. With this linear converging/diverging reactor design, the increasing axial magnetic field inside the converging plasma flow duct can achieve ultra-high magnetic fields limited only by the amount of current and compressive strength of the conductor used to construct the solenoid. Since the magnetic pressure acting on a plasma moving in a magnetic field increases with the square of its intensity, a magnetic field on the order of 100 T will generate an enormous inward magnetic compressive force on an ionized plasma while simultaneously pulling it along the axis towards the fusion ignition point by the solenoid's very high magnetic field gradient. The effect is the creation of a super magnetic pinch where, in principle, the magnetically compressed plasma approaches an infinite density as it approaches the convergence point. By designing the reactor solenoid as a hybrid converging/diverging superconducting coil where the low magnetic field near the front of the reactor is superconducting, and the portion of the solenoid near the end of the reactor where the coil is thickest is non-superconducting, but capable of carrying ultra high current and compressive loads, the magnetic field near the converging point of the plasma flow duct can be very high exceeding 100 T. Magnetic fields on this order will generate magnetic compressive forces on a plasma so great that the resulting ultra high densities will make it possible to achieve essentially any fusion reaction desired that includes all of the clean nuclear fusion reactions that generate no neutrons. Fusion ignition is achieved by a plurality of high power phase-coherent pulsed laser beams converging to an ignition point at the same instant where the plasma density is maximum. The power generated by the fusion reactor is controlled by controlling the mass flow rate of the plasma injected into the reactor.

A secondary magnetic confinement solenoid is mounted around the ignition point that magnetically deflects and focuses the ionized reaction products into a directed beam of high energy charged particles (i.e., an electric current of very high power) which is fed into a high-field superconducting MED electric generator. By designing the MHD generator to operate at very high efficiencies, almost all of the fusion power generated by the reactor can be converted directly into electrical power. Consequently, the present invention will provide a fusion reactor capable of converting unlimited amounts of fusion energy directly into clean non-polluting electrical energy at nearly 100% efficiency without generating any polluting waste products at a fraction of the cost of any prior art conventional fuel-burning, or nuclear fission electric power plant that generates enormous amounts of chemical and radioactive waste products and environmental pollution.

### BRIEF DESCRIPTION OF THE FIGURES

These and other advantages and features of the invention will be apparent from the disclosure, which includes the specification with the foregoing and ongoing description, the claims and the accompanying drawings wherein:

FIG. 1 is a schematic longitudinal cross-section of the linear converging/diverging design of the fusion reactor showing its converging internal plasma flow duct and its diverging external magnetic confinement solenoid showing its increasing wall thickness for achieving an ultra high plasma density at the ignition point required for achieving a clean, neutron-free, fusion reaction;

FIG. 2 is a schematic transverse cross-section of one coil segment of the converging/diverging fusion reactor solenoid showing the multiple layers of the current carrying cable mounted around the internal converging plasma flow duct;

FIG. 3 is a schematic longitudinal cross-section of the coil segment of the fusion reactor solenoid shown in FIG. 2;

FIG. 4 is a schematic transverse cross-section of a large plurality of micro-plasma injectors mounted in front of the reactor's converging plasma flow duct that injects a plasma into the duct in directions parallel to the lines of magnetic induction passing through their centers;

FIG. 5 is an enlarged schematic transverse cross-section of the converging plasma flow duct showing how the plasma is magnetically compressed into a narrow cylindrical region around its longitudinal central axis to very high densities generating a super magnetic pinch effect as it is pulled through the duct toward the fusion ignition point by the increasing magnetic field of the converging/diverging confinement solenoid;

FIG. 6 is a schematic transverse cross-section of the fusion reactor showing a belt of 72 pulsed laser generators that generate a pulse of 72 phase-coherent 50 KW laser beams that simultaneously impact and heat the magnetically compressed plasma at the ignition point at the same instant that triggers the fusion reaction;

FIG. 7 is a schematic longitudinal cross-section of the converging/diverging fusion reactor, its magnetic deflecting nozzle mounted at the end of the reactor that focuses the charged fusion reaction particles into a directed beam moving at ultra high velocity through an evacuated cylinder that is fed into a high-efficiency superconducting MHD electric generator thereby converting nearly all of the fusion energy generated by the fusion reactor directly into clean electrical energy without generating any pollution or radioactive waste products;

FIG. 8 is an enlarged schematic transverse cross section of a single superconducting coil element of the reinforced superconducting cable used in the construction of the fusion reactor solenoid illustrating its interlocking triangular design and construction;

FIG. 9 is a schematic transverse cross section of one superconducting cable composed of many individual interlocking triangular coil elements illustrating its external hexagonal cross-sectional shape; and

FIG. 10 illustrates an alternative method for converting the fusion energy generated by the fusion reactor into electrical energy using a conventional steam turbine electric generating system.

### DESCRIPTION OF THE PREFERRED EMBODIMENT

The invention presented herein is a linear converging/diverging high plasma density fusion reactor and operating method designed for achieving essentially any fusion reaction desired. In the preferred embodiment the reactor is designed for generating bulk electric power for industry and commerce. In order to eliminate any harmful radioactive byproducts inherent in all prior art fission and fusion reactor designs, the preferred embodiment of the reactor will be designed to operate using a clean nuclear fusion reaction that generates no spurious neutrons that would make the reactor structure, and everything around it, highly radioactive. Table 1 is a list describing several clean fusion reactions and the energy generated therefrom. (See page 41 in Advanced Propulsion Study, AFRL-PR-ED-TR-2004-0024, Air Force Research Laboratory, Edwards Air Force Base, Calif. 93524 by Eric W. Davis.)

TABLE 1
Clean Nuclear Fusion Reactions That
Generate No Neutrons Or Radioactivity

| | Energy Generated | Specific Energy Ê |
|---|---|---|
| Fusion Reaction | (MeV) | (J/gm) |
| p + ¹¹B → 3 ⁴He | 8.7 | 4.364 × 10¹⁰ |
| p + ⁶Li→ ⁴He + ³He | 4.0 | 3.436 × 10¹⁰ |
| ³He + ⁶Li→ 2 ⁴He + p | 16.9 | 1.131 × 10¹⁰ |
| D + ⁶Li→ 2 ⁴He | 22.4 | 1.686 × 10¹¹ |
| D + ³He→ ⁴He + p | 18.3 | 2.204 × 10¹¹ |
| ³He + ³He→ ⁴He + 2p | 12.9 | 1.295 × 10¹¹ |

Since ³He is very difficult to obtain, fusion reactions 3, 5, and 6 involving this substance will be impractical. Deuterium however, is easily available from the distillation of ordinary sea water with an abundance of 1.0 kg per 36 m³ of water. (See page 499 of The Encyclopedia of Physics, 3^{rd} Edition, Van Nostrand Reinhold, New York, 1990.) Consequently, since lithium is also easily available from various minerals and from sea water, (see page 19 in the Clery book) the fusion reaction used in the preferred embodiment of the invention will be 4^{th} reaction D+⁶Li→2⁴He having a specific energy output Ê of 1.686×10¹¹ J/gm.

As a comparison, the specific energy content of fuel oil burned in large electric power plants is 4.38×10⁴ J/gm. (See page 1754 in, Handbook of Chemistry and Physics, 1953, Chemical Rubber Publishing Co. Cleveland, Ohio) Hence, the fuel used in the preferred embodiment of the fusion reactor invention has an energy density that is 3,850,000 times greater than prior art fuel burning bulk electric power plants and generates zero atmospheric pollution, and zero radioactive waste products. And, unlike all nuclear fission power plants, the cost of the fusion fuel is negligible.

Prior art theoretical studies on the possibility of achieving a self-sustaining controlled nuclear fusion reaction indicate that the required plasma densities will have to be about 10²⁰ ions/m³ and the trigger that will start a fusion reaction in the compressed plasma region is initiated by a heat source at a temperature of about 10⁸ K. (See “Fusion Power,” pages 499-508 in The Encyclopedia of Physics, 3^{rd} Edition, Van Nostrand Reinhold, New York, 1990, by R. Besancon.) Since the fusion reaction temperatures are so high, the plasma can only be confined away from the interior walls of the reactor by very high magnetic fields. The most promising prior art reactor design that magnetically contains the hot plasma away from the walls is a superconducting toroid known as the “Tokamak.” Unfortunately, research on this reactor design has been going on for over 50 years without ever achieving any sustained fusion reaction. (See pages 304-307 in the Clery reference.)

The fusion reactor disclosed in the present invention is based on an entirely different reactor design which will provide plasma confinement, plasma compression, unlimited plasma densities, plasma ignition, and ejection of the high energy fusion reaction products out of the reactor all in one unit. To achieve this operating performance the basic reactor design will have a linear diverging/converging geometry with an external diverging magnetic confinement and compression solenoid having increasing wall thickness that encloses an internal plasma flow duct that converges to a point at the end of the reactor where, in theory, the plasma density becomes infinite.

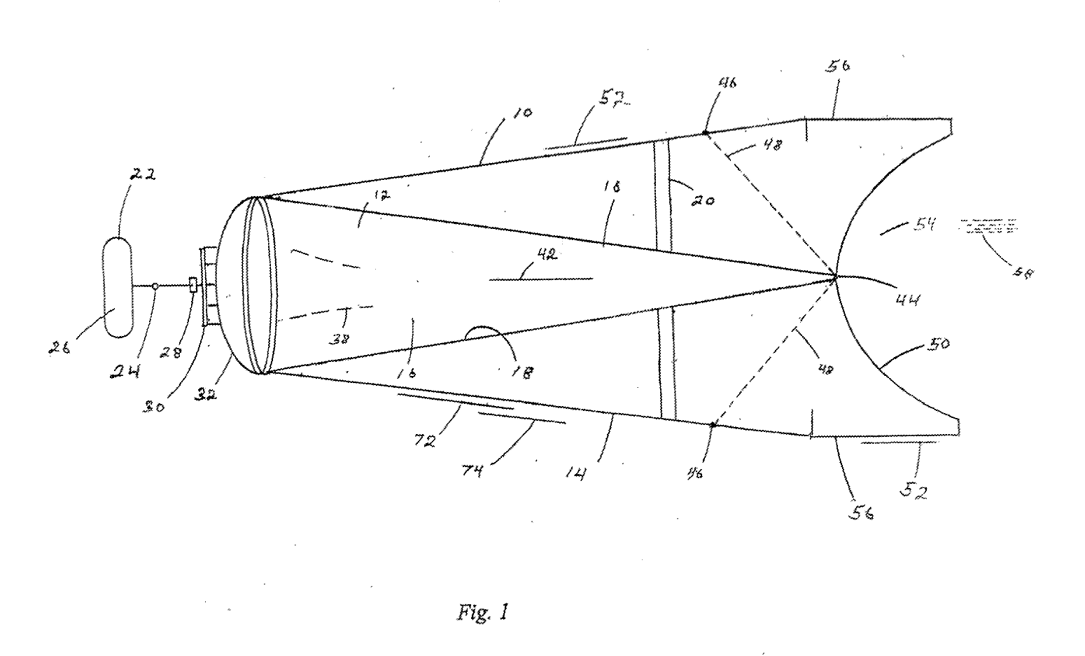

FIG. 1 is a schematic longitudinal cross-section of the fusion reactor 10 that is specifically designed to generate essentially unlimited plasma densities, limited only by the strength of the magnetic field generated by the reactor's containment solenoid. Referring to FIG. 1, the magnetic confinement and compression process of the injected ionized hydrogen gas 12 is achieved by a linear converging/diverging high-field hybrid superconducting solenoid 14, enclosing an inner converging conical plasma flow duct 16 having non-contacting magnetic walls 18, that converges to a point near the end of the duct 16 thereby achieving, in principle, unlimited plasma densities as the longitudinal distance x along the duct approaches the end of the duct 16 (limited only by the current carrying capacity and strength of the hybrid superconducting solenoid 14).

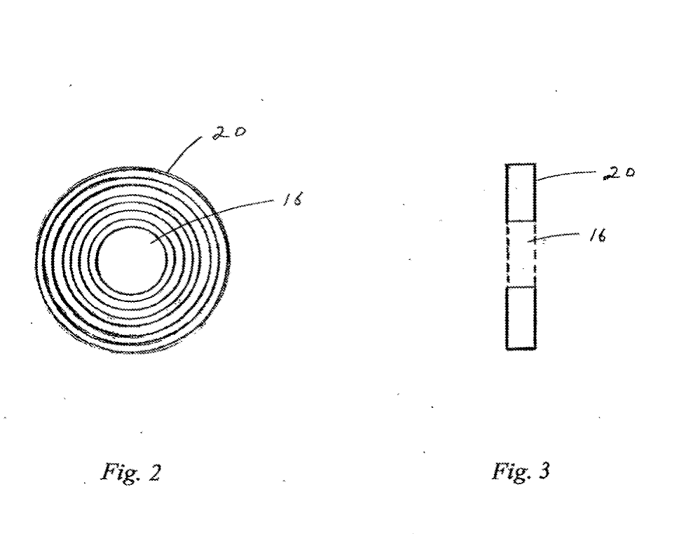

FIGS. 2 and 3 are schematic transverse and longitudinal cross-sections, respectively, of one of the co-axial coil segments 20 of the linear converging/diverging fusion reactor solenoid 14. As shown in FIG. 1, all of the transverse current-carrying coil segments 20 of the solenoid 14 have an increasing outer radius Rₓ and a decreasing inner radius rₓ. The center inner radius rₓ of each coil segment 20 at a distance x from the front of the fusion solenoid 14 is equal to the radius of the inner plasma flow duct 16 at distance x from the front of the solenoid 14. Referring to FIG. 1, in the preferred embodiment, the linear converging/diverging reactor solenoid 14 will be 8 m (26.24 ft) long and 2 m (6.56 ft) in diameter at the front where x=0 m. The diameter at the end where x=8 m is 4 m (13.12 ft). Thus, with this design, the wall thickness of the solenoid 14 significantly increases as the distance along the duct increases. For simplicity, the inlet diameter of the internal converging conical plasma flow duct 16 is also designed to be 2 m (6.56 ft). As described above, the diameter of the plasma flow duct 16 gradually decreases along the duct that converges to a point at the end of the reactor where x=8 m. With this converging/diverging design of the reactor solenoid 14, the coil thickness at the beginning of the reactor 10 will (for simplicity) be assumed to be 1.0 m−1.0 m=0 m, and 2 m−0 m=2.0 m (6.56 ft) at the end of the solenoid. These external design dimensions of the hybrid superconducting fusion reactor solenoid 14 will be denoted by L=8 m, R₁=1 m, and R₂=2 m. The dimensions of the internal conical plasma flow duct 16 will be denoted by L=8 m, r₁=1 m, and r₂=0 m.

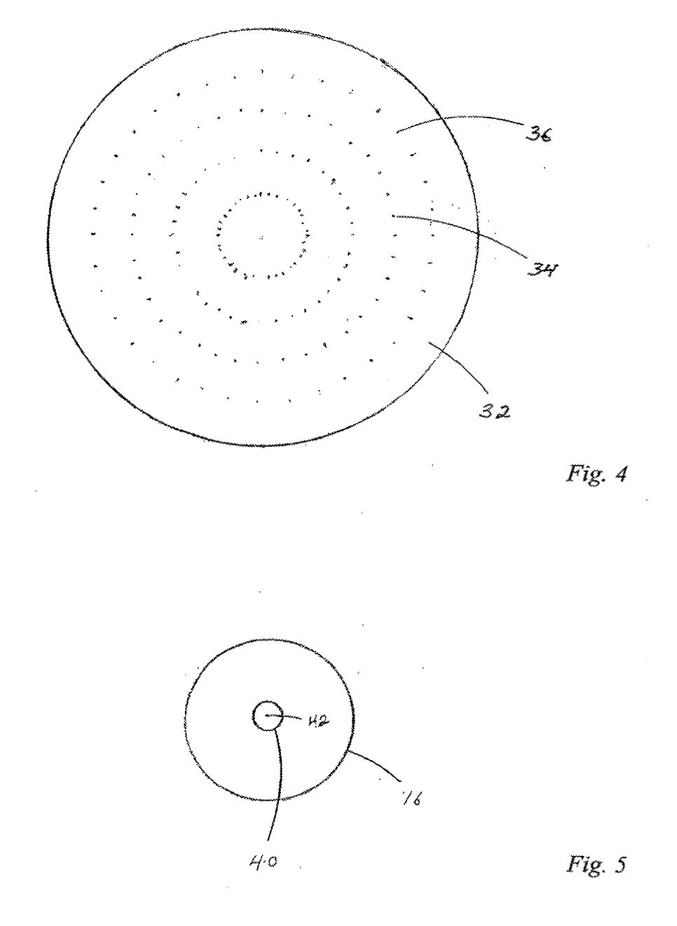

Referring to FIG. 1, a fuel storage vessel 22 is mounted in front of the fusion reactor 10. A very small fuel extraction system 24 is mounted directly behind this vessel 22 that withdraws the fusion fuel 26 at an extremely low mass flow rate. After the fuel 26 is withdrawn from the storage vessel 22, it is fed into a small pre-injection processor 28 where the ratio of the fusion components of the fusion fuel is precisely controlled. After leaving the pre-injection processor 28, the fuel is fed via a distribution system 30 into an ionized gas fuel injection system 32 of the fusion reactor 10 which comprises several thousand individual micro-injectors 34 mounted in a circular configuration as shown in FIG. 4 to obtain a uniform very low plasma density.

Referring to FIG. 4, the ionized gas injection system 32 comprises a large plurality of micro-injectors 34 mounted in circles with increasing radii out to about 0.8 m. Each of these micro-injectors 34 is designed to inject a very narrow stream of the ionized gas into the duct 16 in directions along the line of magnetic induction passing through their centers 36 such that the ionized gas flows through the duct 16 along the magnetic lines of induction 38 passing through the duct generated by the magnetic field of the fusion reactor solenoid 14. FIG. 5 is an enlarged schematic transverse cross-section of the converging conical plasma flow duct 16 showing how the plasma is magnetically compressed inward on all sides into a very narrow cylindrical region 40 around the longitudinal central axis 42 of the duct 16 thereby achieving very high plasma densities as it is pulled through the duct toward the fusion ignition point by the increasing magnetic field gradient of the converging/diverging magnetic solenoid of the fusion reactor. With this converging/diverging design of the fusion reactor, it will be possible to generate very intense magnetic fields along the conical plasma flow duct to achieve the extremely high plasma densities required for achieving the desired fusion reaction at the plasma ignition point.

In the preferred embodiment of the invention, the converging/diverging hybrid superconducting reactor solenoid 14 will be designed to generate an axial magnetic field of 15 T at the beginning of the duct 16, and 100 T at the end where the coil thickness is very nearly 2 m (6.56 ft). (The electromagnetic analysis used in this disclosure is based on mks units where magnetic field intensity B is given in weber/m² where 1.0 webers/m²=10⁴ Gauss=1.0 Tesla.) In order to quantitatively determine the performance of the present fusion reactor, the disclosure will now present a detailed analytical analysis based on the overall reactor dimensions given above.

Let \vec{ν}ₚ denote the velocity vector of a single ion after it is injected into the reactor's plasma flow duct 16 from its micro-injector 34 where the magnetic field inside the duct 16 is denoted by \vec{B}. The resulting magnetic force \vec{F}_{P} acting on the ion due to the magnetic field is

\vec{F}_{P}=q\vec{ν}_{P}×\vec{B} (1)

where q is equal to the charge of the ion. (See page 229 in Electricity And Magnetism, Addison-Wesley Publishing Co., Inc. Cambridge Mass., 1951 by Francis Sears.) The ions are injected into the duct with velocities parallel to the magnetic field vector. Since the velocity vector \vec{ν}ₚ of the ions are parallel to the magnetic vector \vec{B}, it follows from Eq(1) that the magnetic force vector \vec{F}ₚ=0. Hence, the ions continue to follow the converging lines of magnetic induction B of the magnetic field inside the plasma flow duct 16 with the same initial injection velocity νₚ. Since the lines of magnetic induction through the plasma flow duct are nearly parallel to its longitudinal central axis 42, the velocity of the plasma through the duct is very nearly constant and equal to the injection velocity. Hence,

ν_{IN}=ν_{OUT}=ν_{P}=injection velocity (2)

The plasma flowing through the duct 16 is prevented from physically contacting the walls 18 of the duct 16 by the magnetic pressure P_{M} exerted on the plasma inward on all sides toward the longitudinal central axis 42 of the duct 16 generated by the magnetic field B of the reactor solenoid 14. The equation giving this magnetic pressure is

$${P}_{M} = \frac{{B}^{2}}{2 {μ}_{0}} \qquad ( 3 )$$

where μ₀ is a constant equal to the magnetic permeability of free space with value (in mks units) equal to 4π×10⁻⁷ webers/amp-m. (See page 267 in Introduction To Electromagnetic Fields, McGraw-Hill Book Company, Inc., 1958 by Samuel Seely.) As shown in FIG. 1, by designing the reactor solenoid 14 as a linear converging/diverging solenoid, the external radius increases while the internal radius simultaneously decreases along the central axis 42. Hence, the coil thickness of the solenoid 14 around the internal converging plasma flow duct 16 significantly increases along its longitudinal central axis 42. This design feature of the fusion reactor 10 enables the magnetic field intensity B, and plasma density ρ, along the longitudinal axis 42 of the duct 16 to significantly increase along the duct such that at the end of the duct (near the fusion ignition point), the plasma density can be designed to be extremely high and, in principle, unlimited. (Limited only by the maximum current carrying capacity of the solenoid coil, and its structural compressive strength.) This is how essentially any desired fusion reaction requiring very high plasma densities can be achieved by the present invention.

Referring to FIG. 1, let the apex angle of the converging conical plasma flow duct 16 be denoted by α. Let x denote the distance along the longitudinal central axis 42 from the beginning of the duct. Let L denote the length of the fusion solenoid 14. With this notation, the inner radius rₓ and the transverse cross-sectional area Aₓ of the plasma flow duct 16 at point x are given by

rₓ=(L−x)tan(α/2) Aₓ=π[(L−x)tan α/2]² (4)

Hence, as x increases, the cross-sectional area Aₓ of the plasma flow duct 16 gradually decreases until it becomes zero at the end of the duct 16 where x=L. In the preferred embodiment, L=8 m and the inlet radius R_{IN} r₁=R₁=1 m. Hence,

$$\frac{1}{2} α = {tan}^{- 1} ( \frac{{R}_{1}}{L} ) = {7.125}^{o} \qquad ( 5 )$$

In order to achieve the very high plasma densities and ignition temperatures required for achieving the desired fusion reaction at the plasma ignition point x_{IP}, the diameter of the of the plasma flow duct 16 at the fusion ignition point will be designed to be 0.1 mm=10⁻⁴ m. Hence, the radius r_{IP} of the plasma flow duct 16 at the fusion ignition point is 5×10⁻⁵ m. Consequently, the cross-sectional area A_{OUT} of the plasma flow duct at point x_{IP} is given by

A_{OUT}=πr_{IP}²=7.854×10⁻⁹ m²

In view of Eqs(4), the distance x_{IP} of the fusion ignition point is given by

$${x}_{IP} = L - ( \frac{{r}_{IP}}{tan ( \frac{a}{2} )} ) = 8 - \frac{5 {10}^{- 5}}{0.12500} = 7.99960 m \qquad ( 6 )$$

In view of the conservation of mass flow rates, it follows that the mass flow rate of the ions entering the duct at x=0 denoted by \dot{m}_{IN} is equal to the mass flow rate of the ions leaving the duct at the fusion ignition point 44 denoted by \dot{m}_{OUT}. Hence

\dot{m}_{IN}=\dot{m}_{OUT} (7)

Consequently, if the corresponding ion densities and longitudinal velocities at these points are denoted by ρ_{IN}, ν_{IN} and ρ_{OUT}, ν_{OUT}, respectively, it follows from Eq(7) that

A_{IN}ν_{IN}ρ_{IN}=A_{OUT}ν_{OUT}ρ_{OUT} (8)

By setting A_{OUT}=Aₓ, it follows from Eqs.(4) and (8), that if (assuming for simplicity) the plasma fills the entire transverse cross-sectional area of the duct, the corresponding theoretical plasma density ρ_{IN} entering the duct at point x=x_{IN}=0 is given by

$${ρ}_{IN} = \frac{{ρ}_{OUT} {{v}_{OUT} [ ( L - {x}_{OUT} ) tan ( \frac{a}{2} ) ]}^{2}}{{v}_{IN} {R}_{IN}^{2}} \qquad ( 9 )$$

In view of Eq(2), this fundamental plasma density equation of the invention becomes

$${ρ}_{IN} = \frac{{{ρ}_{OUT} [ ( L - {x}_{OUT} ) tan ( \frac{a}{2} ) ]}^{2}}{{R}_{IN}^{2}} \qquad ( 10 )$$

In order to illustrate the operational performance of the fusion reactor described by the above equations, suppose that the desired plasma density ρ_{OUT} for achieving a certain fusion reaction is ρ_{OUT}=3.306×10³¹ (ions/m³) which is the plasma density at the core of the sun. (See “Internal Structure of the Sun,” pages 787-789 in Encyclopedia of Planetary Science, Chapman & Hall, New York, 1997.) Suppose also that at this density, x_{OUT}=7.99960 m. Consequently, it follows from Eq(10) that the corresponding plasma density ρ_{IN} entering the fusion reactor at point x_{IN}=0 would be

$${ρ}_{IN} = \frac{{{ρ}_{OUT} [ ( L - {x}_{OUT} ) tan ( \frac{a}{2} ) ]}^{2}}{{R}_{IN}^{2}} = \frac{3.306 {{10}^{31} [ ( 8 - 7.9996 ) tan {7.125}^{0} ]}^{2}}{1} = 8.265 {10}^{22}$$

The ion number density ρₓ at any point x in the plasma flow duct where the cross-sectional area is denoted by Aₓ is given by

$${ρ}_{x} = \frac{{ρ}_{IN} {A}_{IN}}{{A}_{x}} \qquad ( 11 )$$

For simplicity, the magnetic field B(x) of the converging/diverging magnetic compression solenoid 14 of the fusion reactor 10 will be designed as a simple function of x that increases linearly as x increases along the conical flow duct such that B=15 T at the front of the reactor where x=0, and equal to 100 T at the end where x=8 m. Hence, the value of the magnetic field at any point x along the longitudinal central axis of the solenoid is given by the equation

B=(10.625x+15)T (12)

With this solenoid design, the magnetic field B at the fusion ignition point where x=7.99960 m will be 99.996 T. Consequently, in view of Eq(3), the magnetic compression of the plasma at the fusion ignition point will be

$${P}_{M} = \frac{{B}^{2}}{2 {μ}_{0}} = 3.97854 {10}^{9} N \text{/} {m}^{2} = 576 , 984 lbs \text{/} {in}^{2}$$

Table 2 gives the numerical values of the magnetic field Bₓ, magnetic pressure Pₓ(N/m²), cross-sectional area of the plasma flow duct Aₓ (m²), and the plasma number density ρ (ions/m³), at various distances x(m) of the above example of a fusion reactor simulating the core of the sun where ρ_{OUT}=3306×10³¹ ions/m³ The Table is intended to show how the invention can increase the initial plasma density fed into the reactor by 10 orders of magnitude, far surpassing anything in the prior art, to achieve essentially any fusion reaction desired.

TABLE 2
Example Of The Operating Parameters Of The
Linear Converging/Diverging Fusion Reactor

| | | | | Fusion Ignition Density = | |
|---|---|---|---|---|---|
| | L = 8 m, | R₁ = 1 m, | R₂ = 2 m, | 3.306 × 10³¹ (p/m³) | |
| | x(m) | B(T) | P(N/m²) | Aₓ (m²) | ρ (ions/m³) |
| | 0.00 | 15.000 | 8.952 × 10⁷ | 3.1416 | 8.265 × 10²² |
| | 0.50 | 20.313 | 1.642 × 10⁸ | 2.7612 | 9.404 × 10²² |
| | 1.00 | 25.625 | 2.613 × 10⁸ | 2.4053 | 1.080 × 10²³ |
| | 1.50 | 30.938 | 3.808 × 10⁸ | 2.0739 | 1.252 × 10²³ |
| | 2.00 | 36.250 | 5.228 × 10⁸ | 1.7671 | 1.469 × 10²³ |
| | 2.50 | 41.563 | 6.873 × 10⁸ | 1.4849 | 1.749 × 10²³ |
| | 3.00 | 46.875 | 8.743 × 10⁸ | 1.2272 | 2.116 × 10²³ |
| | 3.50 | 52.188 | 1.084 × 10⁹ | 0.9940 | 2.612 × 10²³ |
| | 4.00 | 57.500 | 1.316 × 10⁹ | 0.7854 | 3.306 × 10²³ |
| | 4.50 | 62.813 | 1.570 × 10⁹ | 0.6013 | 4.318 × 10²³ |
| | 5.00 | 68.125 | 1.847 × 10⁹ | 0.4418 | 5.877 × 10²³ |
| | 5.50 | 73.438 | 2.146 × 10⁹ | 0.3068 | 8.463 × 10²³ |
| | 6.00 | 78.750 | 2.468 × 10⁹ | 0.1964 | 1.322 × 10²⁴ |
| | 6.50 | 84.063 | 2.812 × 10⁹ | 0.1104 | 2.352 × 10²⁴ |
| | 7.00 | 89.375 | 3.178 × 10⁹ | 0.0490 | 5.299 × 10²⁴ |
| | 7.50 | 94.688 | 3.567 × 10⁹ | 0.0123 | 2.111 × 10²⁵ |
| | 7.60 | 95.750 | 3.649 × 10⁹ | 0.0079 | 3.287 × 10²⁵ |
| | 7.70 | 96.813 | 3.729 × 10⁹ | 0.0044 | 5.901 × 10²⁵ |
| | 7.80 | 97.575 | 3.812 × 10⁹ | 0.00196 | 1.325 × 10²⁶ |
| | 7.90 | 98.938 | 3.895 × 10⁹ | 0.000491 | 5.288 × 10²⁶ |
| Ign. | 7.99960 | 99.996 | 3.979 × 10⁹ | 7.854 × 10⁻⁹ | 3.306 × 10³¹ |

In order to achieve the required high ignition temperature at the center of the compressed ionized plasma at the fusion ignition point x=x_{IP}=7.9996 m to trigger the fusion reaction, a very high temperature heat source must be delivered to the center of the compressed plasma at the ignition point x=x_{IP}. This required ignition temperature will be about 10⁸K (See “Fusion Power,” pages 499-508 in The Encyclopedia of Physics, 3^{rd} Edition, Van Nostrand Reinhold, New York, 1990, by R. Besancon.)

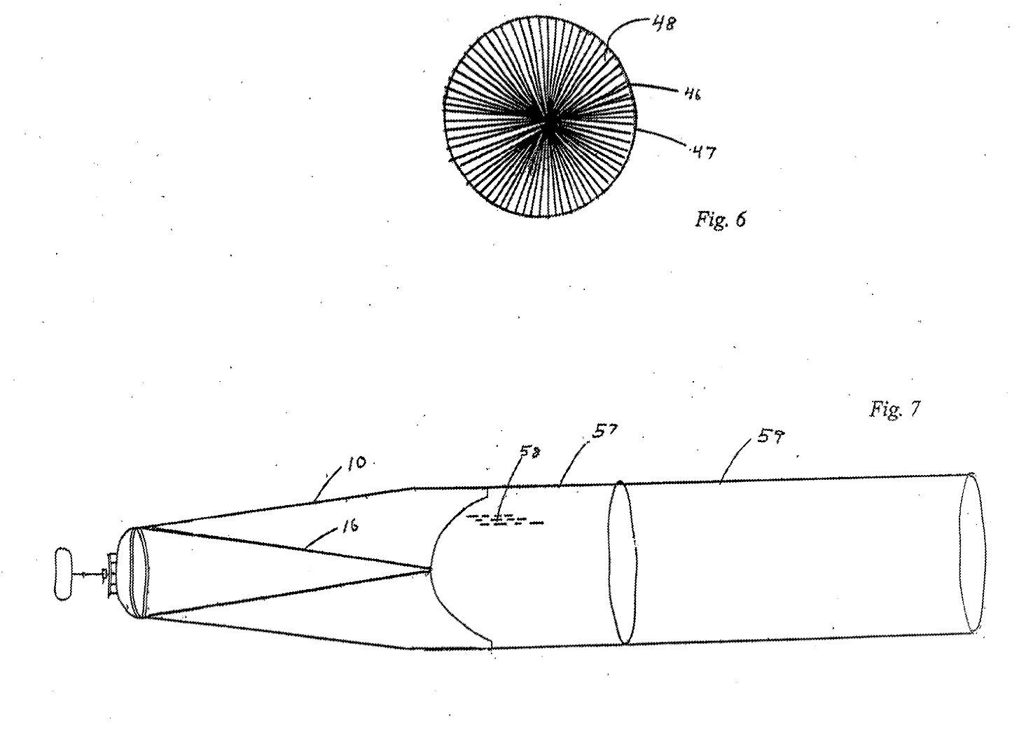

Referring to FIGS. 1 and 6, this high temperature heat source will be generated by a system 72 high power pulsed-laser generators 46 mounted around the outside circumferential periphery of the solenoid 14 on a belt-like mounting frame 47. All 72 laser generators 46 are designed to generate a phase-coherent laser pulse of 50 KW that simultaneously converge at the fusion ignition point 44 with a beam diameter of 0.2 mm. Hence, the radii of all the converging beams 48 is 10⁻⁴ m. As described above, this is equal to the radius r_{IP} of the plasma flow duct at the fusion ignition point x_{IP}=7.9996 m. The system is designed to generate the converging laser pulse for a time duration of 0.1 sec. Consequently, the resulting radiant 0.1 sec heat pulse E_{P} delivered to the ignition point 44 will be

E_{P}=72×(5×10⁴)×0.1=360,000 Joules

The volume V of a sphere having a radius r is given by the equation

V=4/3πr³ (13)

Hence, the converging pulsed laser beams 48 will heat a spherical region at the ignition point 44 having a volume of

V=4/3πr³=4/3π(10⁻⁴)³=4.1889×10⁻¹² m³

Since the number density of this spherical region is 3.306×10³¹ atoms/m³, the mass m is

m=Vρ=(4.189×10⁻¹²)×(3.306×10³¹)×(1.673×10⁻²⁴)=2.316×10⁻⁴ gm

Assuming that the specific heat C of compressed ions is 3.41 cal/gm-K⁰, (see page D-135 in CRC Handbook of Chemistry and Physics, 53^{rd} Edition 1972-1973, CRC Press) the amount of input heat energy E required to heat this spherical plasma region to the required fusion ignition temperature of 10⁸ K is given by

E=CmΔT=3.41×(2316×10⁻⁴)×4.184×10⁸=330,000 Joules (14)

Since the laser generated heat pulse E_{P} is 360,000 Joules, this heat pulse will be sufficient to trigger the fusion reaction in this illustrative example where ρ_{OUT}=3.306×10³¹ ions/m³ (which is far beyond any actual fusion reaction).

The resulting fusion process at the ignition point 44 near the end of the fusion solenoid 14 will result in a great release of energy. However, unlike the detonation of a hydrogen bomb, this release of fusion energy will not have an explosive nature because the ionized helium reaction products will only involve a few micro grams per second which will expand very rapidly. Essentially all of the released fusion energy will appear as kinetic energy of the ionized helium reaction products.

As shown in FIG. 1, a secondary thick-walled hybrid superconducting magnetic confinement solenoid (magnetic nozzle) 56 is mounted at the end of the fusion reactor 10 that is itself generating a very intense shaped magnetic reflection field. The entire solenoid of the reactor 10 is embedded within a cooling system 52 designed to keep the solenoids at very low cryogenic temperatures. The inner walls 50 of the magnetic exhaust nozzle 56 mounted at the end of the fusion reactor 10 are designed in the shape of a 4 m diameter paraboloid of revolution with the focal point very close to the fusion ignition point 44 designed to project a 4 m diameter directed exhaust stream out of the fusion reactor parallel to the reactor's longitudinal central axis 42. Thus, the high velocity expanding ionized helium plasma 54 that approaches the walls 50 of the exhaust nozzle 56 will be magnetically deflected out of the fusion reactor 10 in a directed beam 58 parallel to the reactor's longitudinal central axis 42.

As shown in FIG. 7, this directed 4 m diameter exhaust beam 58 of ultra high velocity charged fusion reaction particles (ionized helium atoms) is fed into an evacuated 4 m diameter cylinder 57 mounted at the end of the exhaust nozzle 56. Since these high energy ionized helium fusion reaction atoms have a positive charge, this directed flow of charged helium atoms 58 flowing through the evacuated cylinder 57 represents an enormous electric current. Consequently, as shown in FIG. 7, by feeding this flow of electric current into a long, 4 m diameter high-efficiency superconducting MHD electric generator 59, almost all of the kinetic energy of the fusion reaction products will be converted directly into electrical energy thereby eliminating the costly and inefficient process of generating the electric power by first generating steam to power traditional steam powered electric generators as in all prior art fission and fuel-burning power plants. (See “A Superconducting Machine for Central Station Power Generation,” in Proceedings of American Power Conference, Vol. 35, pp. 1035-1047, 1973, by Mole, C. J. and Sterrett C.)

Table 3 describes the amount of electric power generated by operating the present fusion reactor with various fuel consumption rates compared to the power generated by a typical large fuel-burning electric power generating plant.

### Nomenclature for Table 3:

Generated electric power (Megawatts)=P(MW)
Required mass flow rate of fuel (D+⁶Li) for the fusion reactor=\dot{m}_{F} (gm/sec)
Required mass flow rate of fuel oil for prior art fuel burning power plants=\dot{m}_{B} (gm/sec)
Cost of power usage rate=C ($/sec)

TABLE 3
Electric Power Generated by the Fusion Reactor Disclosed In The Present
Invention Operating at 100% Efficiency Versus Mass Flow Rate of Fusion
Reactor Fuel Generating No Pollution Compared to Prior Art Fuel Burning
Power Plants Operating at 50% Efficiency Generating Enormous Pollution
(Cost of Fusion Reactor Fuel is $0.0284/gm
Cost of fuel oil is $0.00062898/gm)

| | \dot{m}_{F} | | \dot{m}_{B} | |
|---|---|---|---|---|
| P(MW) | (gm/sec) | C ($/sec) | (gm/sec) | C($/sec) |
| 200 | 1.19 × 10⁻³ | 3.38 × 10⁻⁵ | 9,132 | 5.74 |
| 400 | 2.37 × 10⁻³ | 6.73 × 10⁻⁵ | 18,264 | 11.49 |
| 600 | 3.54 × 10⁻³ | 1.01 × 10⁻⁴ | 27,397 | 17.23 |
| 800 | 4.73 × 10⁻³ | 1.35 × 10⁻⁴ | 36,530 | 22.98 |
| 1000 | 5.93 × 10⁻³ | 1.55 × 10⁻⁴ | 45,662 | 28.72 |
| 1200 | 7.12 × 10⁻³ | 5.77 × 10⁻⁴ | 54,794 | 34.46 |
| 1400 | 8.31 × 10⁻³ | 2.02 × 10⁻⁴ | 63,927 | 40.21 |
| 1600 | 9.50 × 10⁻³ | 3.36 × 10⁻⁴ | 73,059 | 45.95 |
| 1800 | 1.07 × 10⁻² | 2.70 × 10⁻⁴ | 82,191 | 51.70 |
| 2000 | 1.19 × 10⁻² | 3.03 × 10⁻⁴ | 91,324 | 57.44 |
| 3000 | 2.37 × 10⁻² | 3.37 × 10⁻⁴ | 136,986 | 86.16 |
| 4000 | 2.96 × 10⁻² | 4.94 × 10⁻⁴ | 182,648 | 114.88 |
| 5000 | 8.45 × 10⁻² | 8.42 × 10⁻⁴ | 228,311 | 143.60 |

The average amount of power used by a large city over a 24 hour period is about 2,000 MW (2 GW). Table 3 shows that the cost of the fuel consumed in operating the fusion reactor described herein at 2 GW (2,000 MW) continuously for one year would only be $10,625, and the total amount of fuel consumed would only be 377 kg. It would generate zero pollution and no radioactive waste products. Table 3 also shows that the fuel cost of operating a prior art fuel-burning power plant at 2 GW continuously for one year would be $1,811,428,000 (about $2 billion) and would consume 2.88×10⁹ kg of fuel oil. It would also generate an enormous amount of atmospheric and environmental pollution. This is an example of what the present invention will provide.

Although the linear converging/diverging design of the fusion reactor described herein operating with the preferred D+⁶Li→2⁴He nuclear fusion reaction will be possible, the problem of achieving a sufficiently strong magnetic field by the reactor solenoid that surrounds the converging plasma flow duct has to be solved.

Table 4 summarizes the useful magnetic field range and the corresponding critical temperatures for a few high field superconducting materials. (See “State of the Art of Superconducting Magnets”, Journal of Applied Physics. Vol. 42, No. I, January 1971, by Z. Stekly.)

TABLE 4

| | Critical | Critical |
|---|---|---|
| Material | Temperature (K) | Field at 4.2⁰ K (T) |
| Nb₃Sn | 18.2 | 24.5 |
| V₃Ga | 16.8 | 21.0 |
| Nb₃(Al_{0.8}Ge_{0.2}) | 20.7 | 41.0 |
| Nb₃Al | 17.5 | 30.0 |
| Nb—48%Ti (alloys) | 9.5 | 12.2 |

The solution of the problem of designing a superconducting cable that is able to sustain very high stress forces at very high magnetic fields will involve the fabrication of high strength superconducting filaments by vapor depositing a thin coat of high-field superconductor onto a fiber substrate having very high strength. This has already been achieved. It involves the actual fabrication of high strength, low density, superconducting filaments by vapor depositing a thin coat of a high-field superconductor onto a fiber substrate material having very high tensile strength σ and low density ρ. Because of the very high current densities of high-field superconductors, the resulting filaments are then combined to form a superconducting composite cable having a low density ρ and an extremely high tensile strength σ.

The fact that a superconductor can be vapor deposited on high strength, low density, carbon fibers has already been demonstrated in a paper published in 1975. (See “Superconducting Properties of Thin Film Niobium Carbonitrides on Carbon Fibers”, in IEEE Transactions on Magnetics, Vol. Mag-II. No. 2, March 1975, by E. G. Pilce et al.) Additional details for designing incompressible ultra high field superconducting cables can also be found in U.S. Pat. No. 4,078,747 entitled “Orbiting Solar Power Sation,” by M. Minovitch.

For definiteness, it will be convenient to quantify the analysis concerning the design of the high field superconducting cable by a numerical example based on actual experimental data. In one case examined in the above-mentioned paper by E. G. Pilce et al., a coat of niobium carbonitaide superconductor with thickness of 940 Angstrom units (9.4×10⁻⁶ cm) was vapor deposited onto a carbon fiber having a diameter of 7μ (7×10⁻⁴ cm). The density ρ and tensile strength σ of the carbon fiber substrate was 1,900 kg/m³ and 0.32×10¹⁰ N/m³.

In the above case where a 7μ diameter carbon fiber is coated with a thin layer of niobium carbonitride 940 angstroms thick, the critical current density for the niobium carbonitride conductor was measured at 1.5×10⁶ amps/cm². The average critical current density for the coated composite filament can be easily calculated. The result, which will be denoted by J_{C}, is 77,437 amp/cm². The superconducting cable is constructed by joining together in parallel, many individual strands of the coated carbon fibers. Therefore, since this data is based on measured laboratory and engineering experiments, it will be assumed for definiteness, that the superconductor used in the construction of the high-field converging/diverging solenoid of the fusion reactor 10 will be constructed with this composite superconducting cable where the current density J_{C}=77,437 amp/cm². In this case, since the relative amount of the niobium carbonitride superconductor coating is much lower than the amount of the carbon fibre substrate material, the resulting density and tensile strength of the composite superconducting cable will be approximately equal to that of the carbon fibre substrate material. Hence, it's density ρ=1,900 kg/m³ and it's tensile strength σ=0.32×10¹⁰ N/m³.

Since the cable designed for the present fusion reactor 10 must be designed with much higher magnetic fields to magnetically compress the injected ionized gas passing through the plasma flow duct 16 to very high pressures, it will be necessary to design the superconductor capable of operating at much higher magnetic fields. But this will result in much greater compressive deformation. Thus, in order to achieve much higher magnetic fields without compressive deformation, the superconducting cables used in the construction of the reactor's solenoids must be designed to achieve very high compressive and tensile strength. This can be achieved by reinforcing the composite niobium carbonitride/carbon substrate superconducting filament with multiple filaments of “flaw-free” pure fused silica fibers having ultra-high tensile strength. It will be shown herein how this can be achieved, and describe quantitatively, the required proportions of fused silica fibers that must be added to obtain a superconducting cable element (many elements are combined to produce the cable) that will give the required strength to withstand extremely high compressive deformation forces. This will be achieved by designing the superconducting cable of the fusion reactor solenoid as comprising a plurality of interlocking superconducting sub-elements.

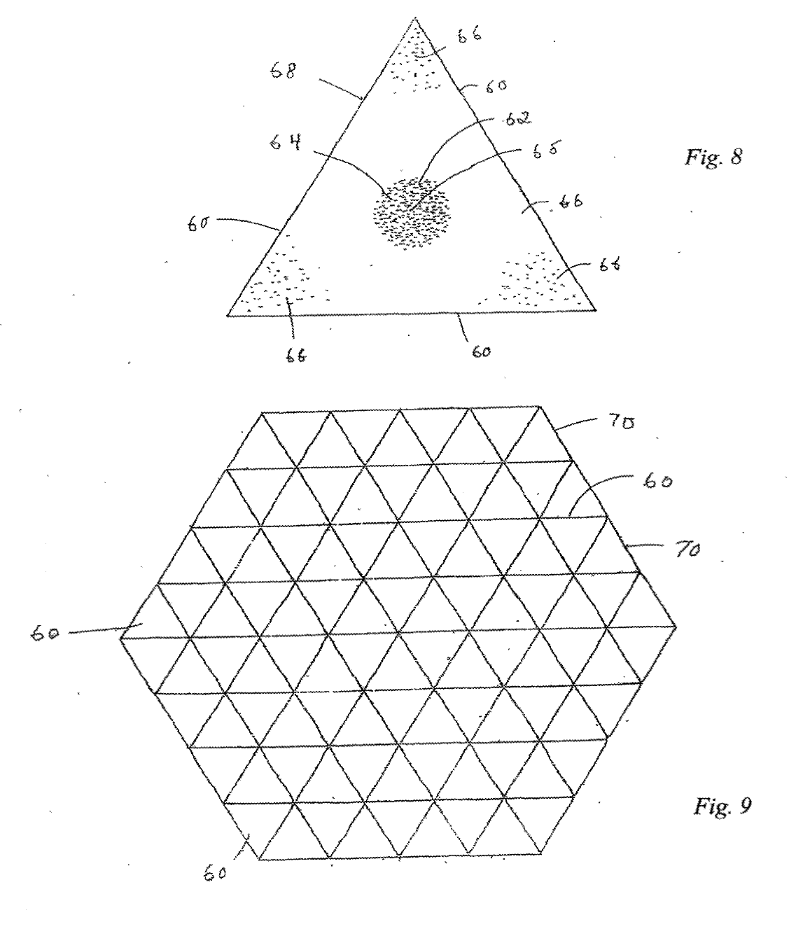

FIG. 8 is an enlarged transverse cross section of a cable element 60 with an appropriate high field superconductor 62 such as niobium carbonitride located in the region 64 close to the center 65 of the cable element 60, defined as the intersection of the perpendicular bisectors. These filaments 62 become the cable element's superconducting core 64. The remaining area of the triangular cross section is occupied by the fused-silica fibers 66. The fibers 66 are bonded together with a resin and the entire cable element 60 is enclosed within a thin jacket of high strength aluminum 68. The cable element 60 is 1.0 cm on the end giving a total cross-sectional area of 0.433 cm².

FIG. 9 is a schematic cross section of one superconducting cable 70 that comprises many of the interlocking triangular superconducting elements 60 illustrating its hexagonal external shape. Thus, in this design, the “packing-fraction” (also known as the “fill-ratio”) of the ultra-high field superconducting cable of the converging/diverging solenoid 14 of the fusion reactor 10 is 1.0 and there is no space left between adjacent cables. This design will be able to sustain extremely high magnetic compressive forces with no displacement of the adjacent superconducting cables.

Since the required magnetic field of the fusion reactor solenoid 14 will be very high, it will be cooled to cryogenic temperatures by a surrounding cryostat 72 (FIG. 1). This cryostat is designed with an active internal cooling system that is designed to absorb the waste heat generated by the reactor by a circulating water system 74.

Since the magnetic field of portions of the reactor solenoid will be very high, the magnetic pressure P, given by Eq. (3), tending to compress the sides of the superconducting cable inward will be very great. However, because of the unique cable design these compressive forces will be within the capabilities of the fused silica and carbon fiber materials. The cables' bulk modulus of elasticity that resists compression deformation will have a minimum value of 8×10¹⁰ N/m²=11,000,000 lbs/in². (See page 165 in, The Physical Properties og Glass, Springer-Verlag, New York Inc, 1973, by D. G. Holloway.) Thus, in principle the fusion reactor solenoid 14 could withstand magnetic fields as high as 300 T before volume compression begins. Since the maximum magnetic fields that superconducting cables can withstand will always increase with improved design and new discoveries in materials research, there is no absolute upper bound on the magnetic field that a superconducting cable can withstand. Hence, in view of Eq.(3), with these ultra high magnetic fields, the fusion reactor solenoid 14 will, in theory, be able to magnetically compress the ionized plasma inside the plasma flow duct 16 to a pressure of 3.6×10¹⁰ N/m² at the ignition point x=x_{Ip} which is much more than required to confine the most difficult Proton+Proton fusion reactions. Magnetic fields exceeding 1,000 T have been observed in astronomical observations. (See page 310 “The Strongest Magnetic Fields in the Universe,” in, The World Almanac And Book Of Facts.)

Referring to FIG. 8 let A_{C} and A_{S} denote the cross-sectional areas of the composite element 60 occupied by the carbon fibers 62 coated with the superconductor and the area that is occupied by the uncoated fused silica filaments 66, respectively, where A=A_{C}+A_{S}=total cross-sectional area of the reinforced superconducting cable element 60. Let the variable η(0≦η≦1) be defined by

η=A_{C}/A_{S} (15)

Consequently, it follows that the cable element's current density J=i/A=ηJ_{C} where J_{C} denotes the current density of the superconducting filaments. With this definition of η, the tensile strength σ and density ρ of the cable element 60 can be expressed by the equations

σ=σ₁η+σ₂(1−η), ρ=ρ₁η+ρ₂(1−η) J=i/A=ηJ_{C} (16)

where σ₁, ρ₁, σ₂ and ρ₂ refers to the tensile strength and density of the carbon fiber filaments and fused silica filaments, respectively and J is the cable's current density. In mks units, the numerical values of these parameters are: σ₁=0.32×10¹⁰ N/m², ρ₁=1,900 kg/m³, σ₂=0.50×10¹⁰ N/m² and ρ₂=2,270 kg/m³ (See page 165 in the above Holloway cited above.) The determination of η will depend upon the design of the magnetic field of the preferred embodiment of the fusion reactor solenoid 14 that will ensure its operability (i.e., a sufficiently strong magnetic field to achieve the magnetic confinement of the fusion reaction plasma).

Omitting the mathematical analysis, it can be shown that for the preferred embodiment of the invention where the length of the linear converging/diverging fusion reactor solenoid is 8 m, and its front and end diameters are R₁=2 m and R₂=4 m, respectively, the value of i that will generate axial magnetic fields of 15 T at x=0 and 100 T at x=8 m will be approximately 0.06. When the magnetic field becomes too high for the superconductor, the current carrying cable is constructed by thin strips of a suitable non-superconducting conductor such as pure copper and designed to undergo a small amount of compressive deformation.

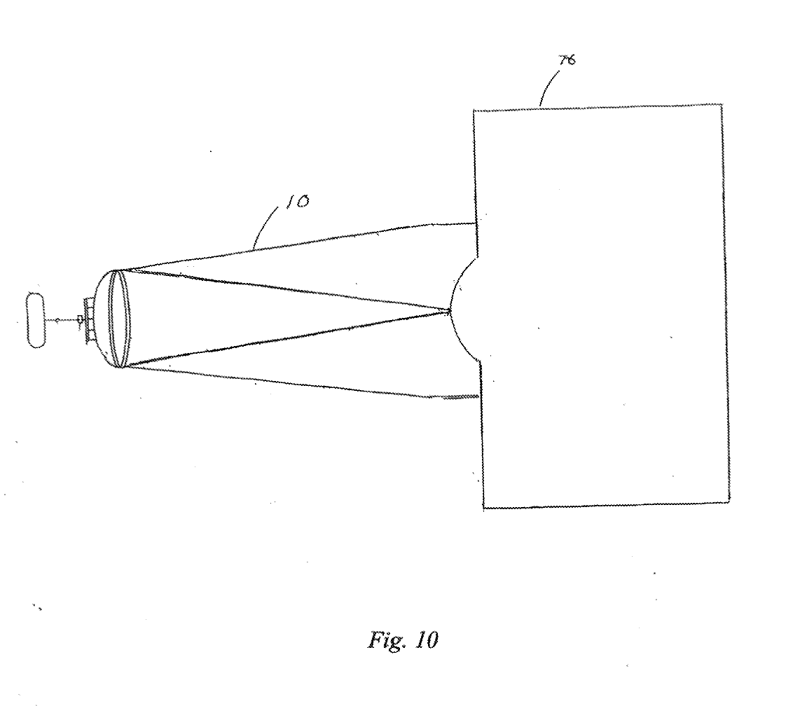

There are many other variations and modifications of the preferred embodiment of the present invention described herein without departing from the spirit and scope of the invention. For example, the fusion reactor could be designed to be much larger or smaller than the preferred embodiment described herein, and could have a different cross-section geometry. It could also have a spiraling geometry with a spiraling internal plasma flow duct that converges to a point surrounded by a spiraling magnetic solenoid. It should also be pointed out that the energy generated by the fusion reactor disclosed herein can be converted into electrical energy by any method desired. For example, FIG. 10 is a schematic illustration of the invention showing how the energy generated by the fusion reactor 10 can be converted into electrical energy by a steam turbine system 76 instead of an MHD system 59 as shown in FIG. 7.

Other clean fusion reactions that generate no neutrons could also be used such as reactions 1 and 2 described in Table 1. Since the reactor generates no spurious neutrons or radioactive products, it is conceivable that the invention could also be designed with very small dimensions for generating small amounts of electric power for private homes, and other domestic applications such as for propelling moving vehicles of all types and sizes. Larger clean fusion reactors could be designed for large manufacturing plants. It should also be noted and emphasized that since innovations in materials research will always result in achieving superconducting and non-superconducting conduits having higher magnetic fields and strength, the operating magnetic fields disclosed in the present embodiment of the invention can be significantly increased to achieve higher performance.

It should also be pointed out and emphasized that the fusion reactor design and its operating method presented in present invention is not limited to any particular fusion reaction. Since it is capable of achieving, in principle, unlimited plasma densities, it can be used for achieving essentially any fusion reaction desired including the very difficult Proton+Proton→He clean reactions.

From the foregoing descriptions, it will thus be evident that the present invention has provided a vastly improved fusion reactor and operating method for generating electric power for industry, commerce and essentially all other applications that generates zero environmental or atmospheric pollution, and zero radioactivity while consuming very little fuel that is inexhaustible and available everywhere at very low cost.

As various other changes and modifications can be made in the above method and apparatus for generating fusion energy without departing from the spirit or scope of the invention, it is intended that all subject matter contained in the above description or shown in the accompanying drawings should be interpreted as illustrative and not in a limiting sense.

What is claimed is:

1. A method for generating a self-sustaining fusion reaction in a plasma comprising the steps of:
mounting a linear converging plasma flow duct containing a plasma having a central longitudinal axis with decreasing transverse radii that converges to a point having a very small radius inside a surrounding solenoid with converging inner walls adjacent said plasma flow duct such that the magnetic field generated by said solenoid increases in intensity along said central axis thereby pulling said plasma through said duct while simultaneously compresses it to very high densities;
heating said compressed plasma to a temperature that triggers a fusion reaction in said compressed plasma; and
injecting a continuous stream of said plasma into said duct such that said fusion reaction is continued in a self-sustaining process after it is ignited by said heat source.

2. A method as defined in claim 1 wherein said linear magnetic compressing solenoid has a diverging external surface and a converging inner surface such that the wall thickness of said solenoid increases along its longitudinal axis and wherein said converging internal plasma flow duct is mounted inside said converging inner walls of said solenoid.

3. A method as defined in claim 1 wherein said heating step comprises focusing a plurality of high power laser beams that converge to a small region inside the compressed plasma.

4. A method as defined in claim 1 further comprising the step of mounting a secondary magnetic solenoid at the end of said linear solenoid that magnetically expels fusion reaction products from said primary solenoid in a directed exhaust stream forming an electric current.

5. A method as defined in claim 4 further comprising the step of feeding said directed exhaust stream into an MHD electric generator thereby converting a large portion of the kinetic energy of said directed exhaust stream into electric power.

6. A method as defined in claim 1 where said fusion reaction of said plasma comprises a fusion reaction that generates no neutrons and no radioactivity.

7. A method for generating a self-sustaining fusion reaction as defined in claim 1 where the fusion reaction of said plasma is the clean D+⁶Li→2⁴He fusion reaction that generates no neutrons or radioactivity.

8. A method for generating nuclear fusion in a plasma comprising the steps of:
mounting a solenoid generating a magnetic field having an inlet and an outlet on a structural frame such that said magnetic field increases inside said solenoid and such that said increasing magnetic field at said outlet is several times greater than said magnetic field at said inlet;
mounting a conduit for conveying a plasma having an inlet and an outlet with decreasing cross-sectional area inside said solenoid immersed in said magnetic field of said solenoid such that the cross-sectional area of said outlet of said conduit is many times smaller than the cross-sectional area of the inlet of said conduit;
injecting a plasma into said conduit having an initial density such that said increasing magnetic field pulls said plasma through said conduit whereby said increasing magnetic field exerts magnetic pressure on said plasma significantly increasing its density as it is pulled through said conduit; and
heating said compressed plasma by a heat source with a sufficiently high temperature to cause nuclear fusion.

9. A method as defined in claim 8 wherein said heating step comprises mounting a plurality of laser generators around said solenoid that projects a system of converging laser beams at the magnetically compressed plasma that heats the compressed plasma to a temperature sufficiently high to achieve fusion in said plasma.

10. A method for generating a self-sustaining fusion reaction in a plasma comprising the steps of:
generating an increasing magnetic field inside a linear solenoid having an inner converging tubular plasma flow duct with an increasing magnetic field for forcing said plasma through said duct such that the strength of said magnetic field at the end of said solenoid is significantly greater than the strength of said magnetic field at the beginning of said solenoid;
heating said plasma near the end of said solenoid with a heat source having a sufficiently high temperature to cause a fusion reaction in said plasma; and feeding additional plasma into said plasma flow duct such that said fusion reaction becomes self-sustaining.

11. A method as defined in claim 10 wherein said heating step comprises mounting a plurality of laser generators around said solenoid that projects a system of converging laser beams at the magnetically compressed plasma that heats the compressed plasma to a temperature sufficiently high to achieve fusion in said plasma.

12. A method as set forth in claim 11 further comprising the step of mounting a secondary solenoid around said fusion reaction for magnetically containing the reaction products of said fusion reaction and expelling said reaction products from said secondary solenoid in a directed exhaust stream.

13. A method as set forth in claim 12 further comprising the step of feeding said directed exhaust stream into an MHD electric generator thereby converting a portion of the kinetic energy of said directed exhaust stream into electric power.

14. A method for generating a self-sustaining fusion reaction as set forth in claim 12 where the fusion reaction of said plasma comprises is the clean D+⁶Li→2⁴He fusion reaction that generates no neutrons or radioactivity.

15. A nuclear fusion reactor for generating a self-sustaining fusion reaction in a plasma comprising:
a primary linear solenoid mounted around a converging internal plasma flow duct generating an increasing axial magnetic field that forces said plasma through said duct while simultaneously compressing it to very high densities;
a heat generating source mounted around said solenoid that heats said compressed plasma to trigger a nuclear fusion reaction;
a secondary magnetic solenoid mounted at the end of said primary solenoid that magnetically expels fusion reaction products generated by said reactor from said primary solenoid;
means for injecting a continuous stream of plasma into said converging plasma flow duct conduit thereby achieving a continuous self-sustaining fusion reaction; and.
means for expelling said reaction products out of said reactor.

16. A fusion reactor as defined in claim 15 wherein said heating means comprises a plurality of high power laser beams that converge to a small region inside the compressed plasma.

17. A fusion reactor as defined in claim 15 wherein said means for expelling said fusion reaction products from said reactor comprises a secondary solenoid mounted around said fusion reaction that magnetically expels said fusion reaction products from said fusion reactor.

18. A fusion reactor as set fourth in claim 15 wherein said fusion reaction products have very high kinetic energy further comprising means for converting said kinetic energy into electrical energy.

19. A fusion reactor as set fourth in claim 18 wherein said means for converting said kinetic energy into electrical energy comprises an MHD electric generator and means for feeding said high energy reaction products into said MHD generator.

20. A fusion reactor for generating a self-sustaining fusion reaction as set forth in claim 15 wherein the fusion reaction generates no neutrons and no radiation.

21. A fusion reactor for generating a self-sustaining fusion reaction as set forth in claim 15 wherein the fusion reaction of said fusion reactor is the clean D+⁶Li→2⁴He fusion reaction that generates no neutrons and no radioactivity.

22. A nuclear fusion reactor comprising:
a linear magnetic solenoid mounted around a converging plasma flow duct such that when energized with an electric current, generates a magnetic field inside said duct that increases in intensity such that when a plasma is introduced into said duct, the increasing magnetic field forces the plasma through said duct while simultaneously increasing its density to very high levels;
means for heating said compressed plasma to a sufficiently high temperature to ignite said compressed plasma in a fusion reaction; and
means for injecting a continuous stream of plasma into said duct to continue said fusion reaction.

23. A nuclear fusion reactor as defined in claim 22 further comprising a secondary magnetic solenoid mounted around the end of said plasma flow duct that magnetically expels fusion reaction products from said reactor in a directed exhaust stream of charged particles with very high kinetic energy.

24. A nuclear reactor as defined in claim 23 further comprising means for feeding said directed exhaust stream of charged particles into an MHD electric generator thereby converting a large portion of the kinetic energy of said directed exhaust stream into electric power.

25. A nuclear fusion reactor as defined in claim 22 where said fusion reaction of said plasma generates no neutrons and no radioactivity.

26. A nuclear fusion reactor as defined in claim 25 where said fusion reaction of said plasma is the clean D+⁶Li→2⁴He fusion reaction that generates no neutrons or radioactivity.

27. A nuclear fusion reactor for generating a self-sustaining fusion reaction in a plasma comprising:
means for generating an increasing magnetic field inside a linear solenoid having an inner converging tubular plasma flow duct with an increasing magnetic field for forcing said plasma through said duct thereby increasing its density;
means for heating said plasma near the end of said plasma flow duct with a heat source generating a sufficiently high temperature to initiate a fusion reaction in said compressed plasma; and
means for feeding additional plasma into said converging plasma flow duct such that said fusion reaction becomes self-sustaining.

28. A fusion reactor as set forth in claim 27 further comprising a secondary magnetic solenoid mounted around said fusion reaction for magnetically containing the reaction products of said fusion reaction and expelling said reaction products from said fusion reactor in a directed exhaust stream.

29. A fusion reactor as set forth in claim 28 further comprising means for feeding said directed exhaust stream into an MHD electric generator thereby converting a portion of the kinetic energy of said directed exhaust stream into electric power.

30. A fusion reactor as set fourth in claim 27 wherein the fusion reaction of said fusion reactor is the clean D+⁶Li→2⁴He fusion reaction that generates no neutrons or radioactivity.

31. A fusion propulsion system as set forth in claim 27 wherein the magnetic field inside said magnetic solenoid exceeds 15 T.
